(19) United States
(12) Patent Application Publication
(10) Pub. No.: US 2005/0117309 A1
(43) Pub. Date: Jun. 2, 2005

(54) Server rack

(76) Inventors: Ralf Rieken, Horn Bad Meinberg (DE); Heinrich Schmidt, Delbruck (DE); Jurgen Droop, Gutersloh (DE); Franz-Josef Knoop, Buren (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/502,817

(22) PCT Filed: Jan. 17, 2003
(86) PCT No.: PCT/DE03/00134

(30) Foreign Application Priority Data
Jan. 25, 2002 (DE) 102 02 917.2

(51) Int. Cl. G06F 1/16

(52) U.S. Cl. 361/724; 361/683; 361/801; 361/686

(57) ABSTRACT

A server rack for holding a plurality of computer systems. In order to prevent the complex detachment of the cabling at the back when changing, maintaining or upgrading the individual computer systems, the server rack has a plugin apparatus (1) into which holding adapters (2) can be plugged which, in turn, can each hold a computer system. The consecutive slot numbers in the plugin apparatus are made available to the fitted computer systems as a location identifier.

The invention relates to a server rack for holding a plurality of computer systems. To date, the computer systems have been permanently installed in a server rack and cabled or wired at the back. It is likewise known practice to integrate the computer systems into “slide-in units” which are connected to the server rack at the side by means of telescopic rails and can be pulled out toward the front in the manner of a drawer for maintenance work or for conversion. The cabling is likewise arranged at the back again. When pulling it out, the system needs to have the cables removed or there need to be special cable guides which carry the cables along as the system moves.

In the meantime, computer systems containing just one vertical module, “thin servers”, are being demanded on the market in order to match the total computer power in a computer network to the power requirements of the application programs through multiple use and to permit continuous growth of the network.

Given said physical shape for 19″ holding systems, the smaller computer systems have a height of 44.45 mm. However, the large number of such small computer systems in a network entails the drawback that the cabling for the individual systems needs to be arranged in a tight space and thus becomes extremely confusing. This results in considerable problems for maintenance work or when further computer systems are added.

The invention is therefore based on the object of demonstrating a solution which simplifies the maintenance, replacement or addition of a new computer system in a server rack.

The invention achieves this object by means of a plugin apparatus for one or more computer systems, where one or more computer systems are held in a respective holding adapter which, firstly, has the connections for the computer systems and, secondly, has the connections for the plugin apparatus, so that the computer systems can be plugged into the plugin apparatus by the holding adapter without additional connections. This moves the cable connections to similar connections on the plugin apparatus.

Combining the plugin apparatus with the holding adapter therefore makes it possible to push single or a plurality of computer systems held in a respective holding adapter into the plugin apparatus and to remove it/them for exchange or for maintenance work without complex detachment of the cabling at the back.

To this end, the holding adapter can be designed just for one computer system, such as a 19″ computer system with a vertical module, a “thin server”, but may also be designed for a plurality of thin servers or for larger computer systems as well.

The holding adapter is advantageously designed such that it encloses the computer systems in the manner of a casing either just at the side or fully and has a frame at the back for the connections on the computer system and on the plugin apparatus.

In line with one preferred embodiment, the plugin apparatus has a locality descriptor for each slot, which can be retrieved by an electronic interface for the computer which is in this slot. The locality descriptors can be displayed to the maintenance personnel on a screen, e.g. in the form of a graphic display, by suitable software programs.

The locality descriptors are advantageously chosen such that a consecutive number is assigned within the plugin apparatus to each occupiable slot either in increasing or decreasing order.

In one development, even when there are a plurality of plugin apparatuses inserted into the server rack, the locality descriptor is passed on from one plugin apparatus to the next, and hence all occupied slots are numbered in sequence over the entire server rack.

The invention is explained in more detail below using two exemplary embodiments which are shown in the figures, in which:

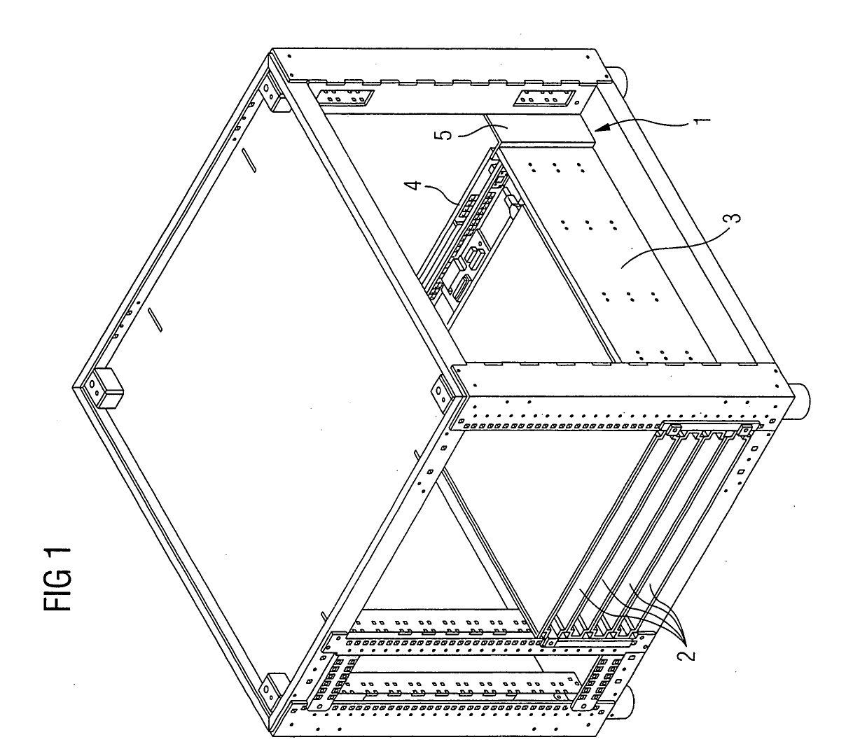

FIG. 1 shows an oblique view of a server rack with a plugin apparatus and four holding adapters for thin servers,

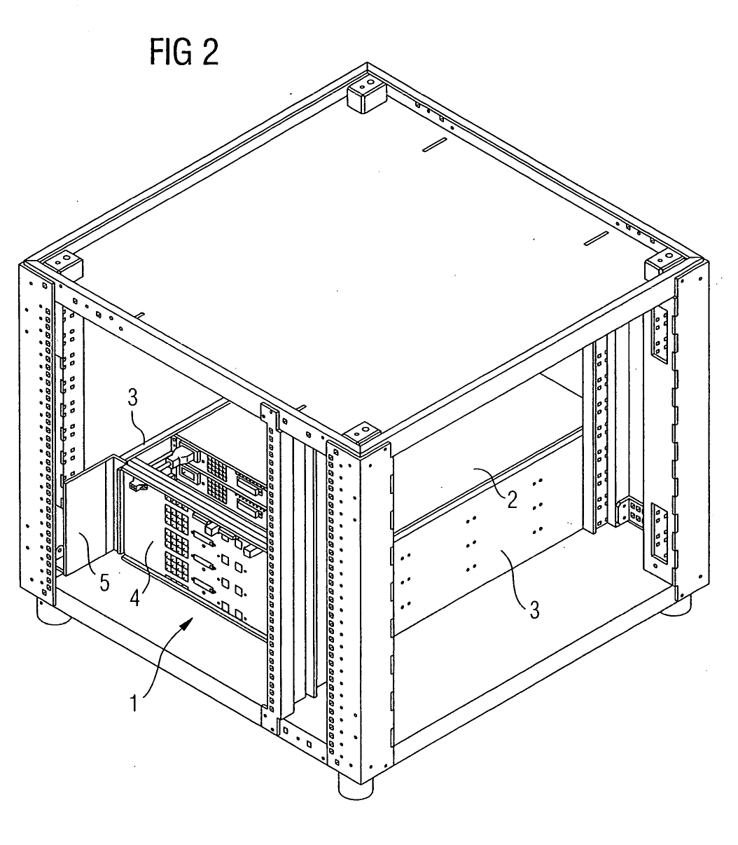

FIG. 2 shows the server rack from FIG. 1 in a view from behind,

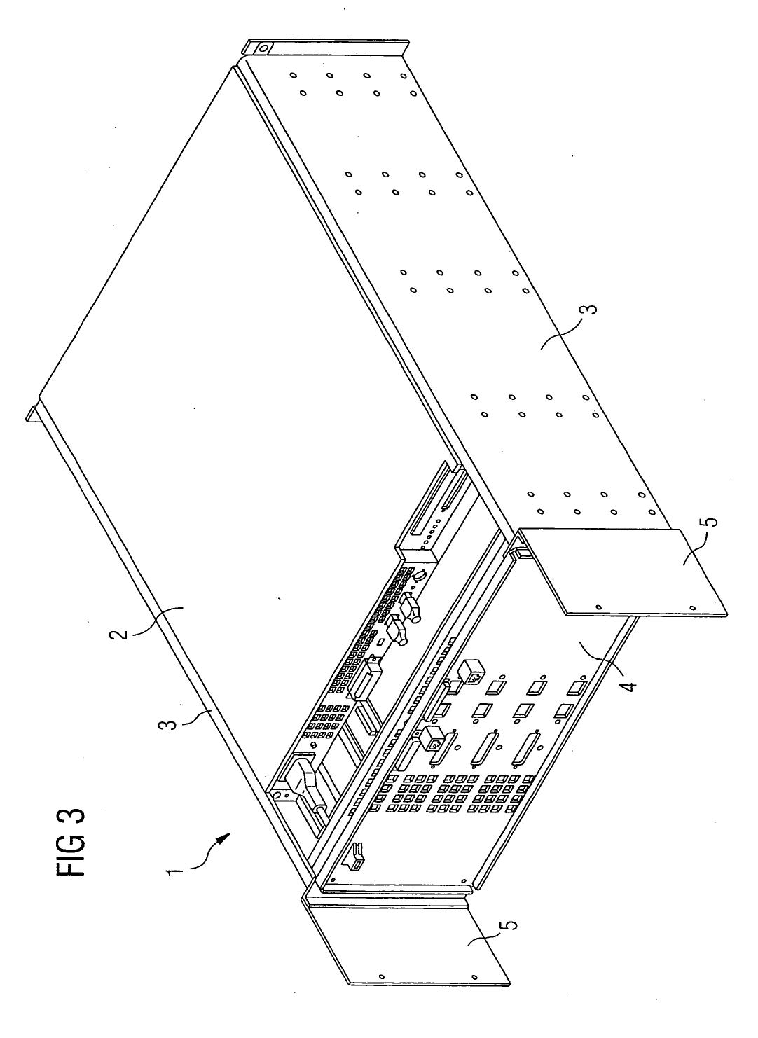

FIG. 3 shows the plugin apparatus with a holding adapter in an oblique view from behind,

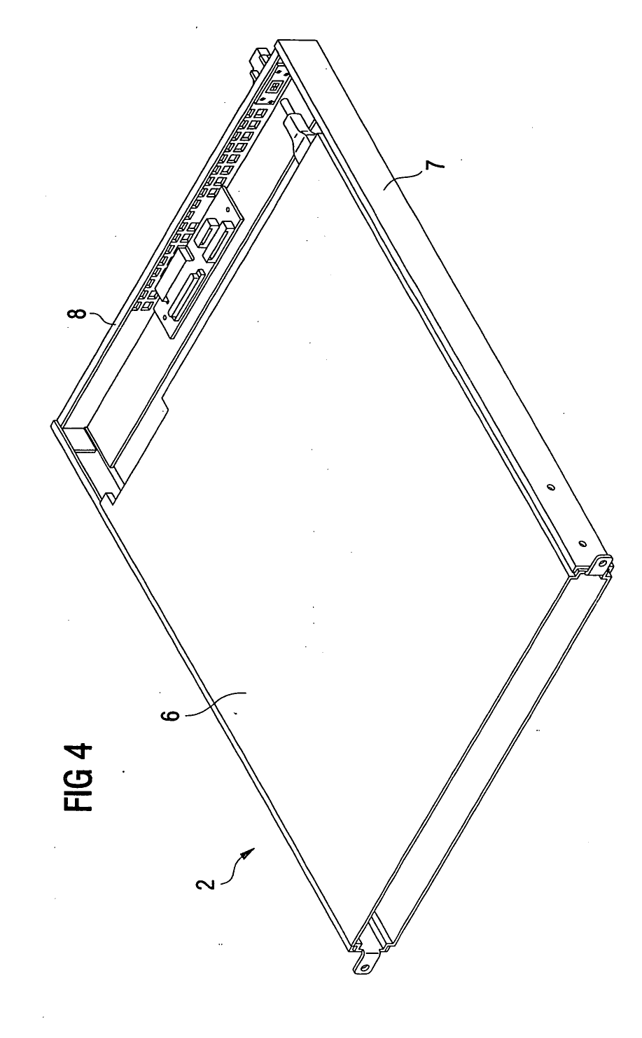

FIG. 4 shows a holding adapter for thin servers in an oblique view from the front, and

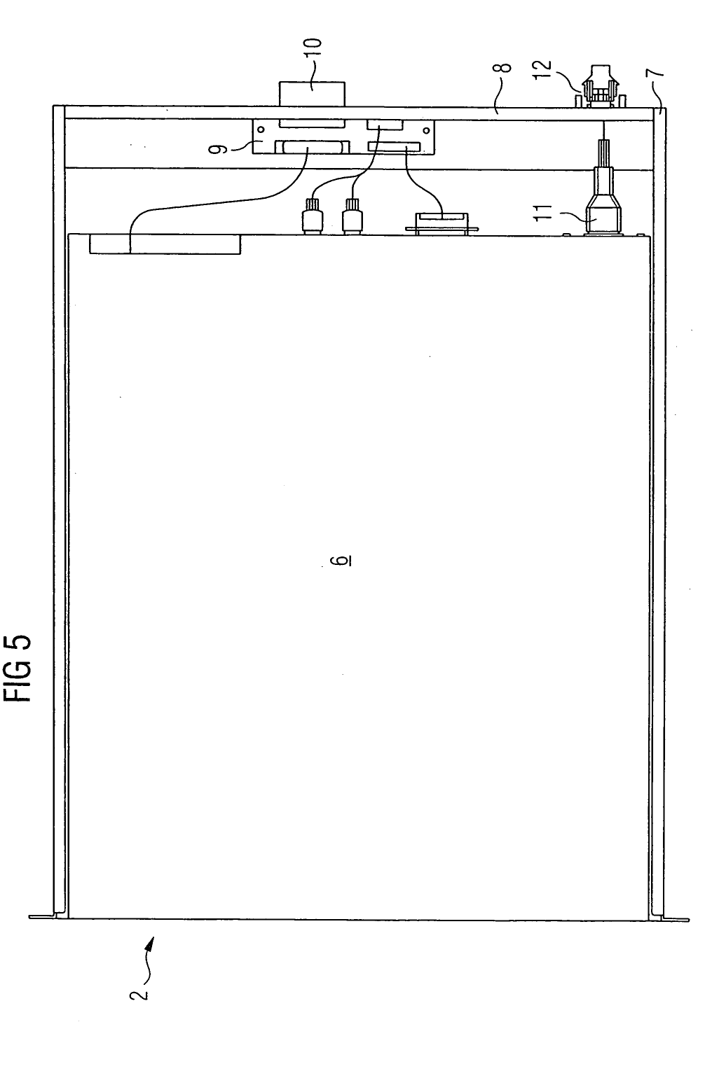

FIG. 5 shows the view in FIG. 4 from above.

FIG. 1 shows an oblique view of a server rack, the side covers for the server rack not being shown. Inside, the server rack holds a plugin apparatus 1 into which four holding adapters 2 have been inserted. The plugin apparatus 1 comprises side flanges 3 and a backplane 4 into which the holding adapters 2 can be plugged. At the side of the backplane 4, there are also flanges 5 for attaching the plugin apparatus to the server rack.

FIG. 2 shows a view from obliquely behind the server rack shown in FIG. 1.

The side flanges 5, firstly, allow the plugin apparatus 1 to be fixed and, secondly, provide a space for the cabling between a plurality of plugin apparatuses and also for supplying the cables to the plugin apparatus.

FIG. 3 shows an oblique rear view of a plugin apparatus in isolation. The holding adapter 2 is merely inserted into a corresponding slot in the plugin apparatus 1.

In the exemplary embodiment shown, the plugin apparatus has four slots arranged one above the other, with just the top slot being occupied by a holding adapter. At the side, the holding adapter is screwed to the side flanges 3 using corresponding holes, or telescopic rails are arranged between the holding adapter 2 and the flanges 3 and can in turn be used to screw in the holding adapters.

FIG. 4 shows the holding adapter 2 in isolation. The holding adapter 2 has a casing-like region 6 which encloses the computer system which is to be held. Attached to the casing-like region 6 at the side is a U-shaped frame 7 which has an end face 8, which is spaced apart from the casing-like region 6 and is in the form of a plugin adapter section. On the inside of the end face 8, it is possible to connect the computer system which is to be held, and the outside of the end face 8 is in a form such that it can be plugged in to the plugin apparatus 1.

FIG. 5 shows the holding adapter 2 from FIG. 4 in a view from above. On the inside of the end face 8 there is a plugin adapter section 9 into which it is possible to plug the regular male connectors for connecting the computer systems. Arranged on the outside of the end face 8 is a male connector 10 which interacts with a female connector in the plugin apparatus 1. On the inside of the end face 8, it is possible to make contact with further connections 11 which likewise have male connectors 12 on the outside of the end face 8, said male connectors 12 interacting with further female connectors in the plugin apparatus 1.

As shown by way of example in FIGS. 1 to 5, one plugin apparatus can hold a plurality of computer systems having just one vertical module. Similarly, it is also possible for a plugin apparatus to hold computer systems having a plurality of vertical modules or a mixture of computer systems having just one and computer systems having a plurality of vertical modules, provided that the type and number of computer interfaces are identical.

1. A server rack for holding a plurality of computer systems, comprising:
a plugin apparatus (1) for one or more computer systems,
a holding adapter (2) for retaining therein one or more computer systems, wherein said holding adapter (2) is secured to said plugin apparatus,
said holding adapter including connections for the computer system(s) and connections for said plugin apparatus, so that the computer system(s) can be plugged into the plugin apparatus by the holding adapter (2).

2. The server rack as claimed in claim 1, wherein
the holding adapter (2) is designed for 19″ computer systems with one or more 44.45 mm vertical modules.

3. The server rack as claimed in claim 1, wherein
the holding adapter (2) encloses the computer system in the manner of a casing and has a U-shaped frame (7) for the connections on the computer system(s) or on the plugin apparatus (1).

4. The server rack as claimed in claim 1, wherein
each slot in the plugin apparatus (1) has a location identifier which can be retrieved by an electronic interface associated with the computer system.

5. The server rack as claimed in claim 4, wherein
the location identifier is numbered consecutively from beginning to end at the slots within a plugin apparatus (1).

6. The server rack as claimed in claim 4, wherein
a plugin apparatus is connected to an adjacent plugin apparatus such that the slots are numbered in sequence over a plurality of plugin apparatuses.
